(19) United States
(12) Patent Application Publication
(10) Pub. No.: US 2013/0224391 A1
(43) Pub. Date: Aug. 29, 2013

(54) METHOD OF CONDITIONING AN APPLICATOR TIP AND DEVICE THEREFOR

(71) Applicant: Pilkington Group Limited, (US)

(72) Inventors: Charles E. Ash, Perrysburg, OH (US); Keith H. Schwaderer, Fremont, OH (US); Shane C. Seiple, Perrysburg, OH (US)

(73) Assignee: Pilkington Group Limited, Lathom (GB)

(21) Appl. No.: 13/779,819

(22) Filed: Feb. 28, 2013

Related U.S. Application Data
(60) Provisional application No. 61/604,682, filed on Feb. 29, 2012.

(51) Int. Cl. B05D 1/28

(52) U.S. Cl. CPC B05D 1/28
USPC 427/429; 118/256

(57) ABSTRACT

A method of conditioning an applicator tip for subsequent use in uniformly applying an adhesion-promoting primer material to a glass vehicle window, and the device for accomplishing such conditioning of the applicator tip are aspects of the invention.

### RELATED APPLICATION

This application is claiming the benefit, under 35 U.S.C. 119(e) of the provisional application filed Feb. 29, 2012 under 35 U.S.C. 111(b) which was granted Ser. No. 61/604,682. This provisional application is hereby incorporated herein by reference in its entirety.

### BACKGROUND OF THE INVENTION

The invention relates to applying an adhesion-promoting primer to a glass substrate. More particularly, the invention relates to a method of conditioning an applicator tip to uniformly apply an adhesion-promoting primer to a glass vehicle window, and the device for accomplishing such conditioning.

Adhesion-promoting primer application systems are known. Various means of ensuring that only the desired amount of a liquid material is applied to a substrate in a precisely defined area or pattern have been described in the patent literature. For example:

U.S. Pat. No. 4,674,144 describes a paint wiping apparatus for removal of excess paint from a paint applicator upon extraction from a paint can. The apparatus includes a pair of spring clips which can be removably insertable into the peripheral groove at the top end of a paint can. An elongated rod has its opposing ends insertable into the spring clips so that the rod spans across the top of the paint can. Upon extraction of a paint applicator from the paint can, the applicator can be wiped against the rod to cause excess paint on the applicator to drip back into the can.

U.S. Pat. No. 5,490,737 describes an assembly for applying a fluid product, including a bottle, a cap to close the bottle, an applicator arranged at an end of a wand attached to the cap, and a wiping device equipped with a lip and fastened to the bottle. When the cap is removed from the bottle, the applicator passes entirely through the wiping device. The flocking fibers remove excess fluid product from the applicator.

U.S. Pat. No. 7,390,533 describes an automated system including a fluid dispenser having an applicator tip which is used to apply a fluid to an object. A compliance mechanism is utilized to assist in maintaining the applicator tip of the fluid dispenser in contact with the object during the coating operation. A robot can be utilized to advance the object past the applicator tip during the coating operation. The fluid dispenser is mounted on a movable arm to allow the fluid dispenser to be moved or rotated into and away from the position where fluid is applied to the object. The automated system is said to provide a fluid application system that can apply a precise and repeatable layer of fluid to an object.

### SUMMARY OF THE INVENTION

The invention relates to applying an adhesion-promoting primer to a glass substrate. More particularly, the invention relates to a method of conditioning an applicator tip to uniformly apply an adhesion-promoting primer to a glass vehicle window, and the device for accomplishing such conditioning.

The applicator to be conditioned is typically a component of an automated priming system, which operates to apply a liquid, adhesion-promoting primer material or the like to a peripheral portion of a glass substrate, for example, a vehicle window which may be supported on an assembly fixture. The applicator may have any configuration suitable for applying such liquid material to at least a part of one or more surfaces of the peripheral portion of such glass substrate. Typically, the applicator includes a connector portion to removably attach the applicator directly or indirectly to a source of the liquid adhesion-promoting primer material or the like. The liquid material preferably flows from the source of liquid adhesion-promoting primer material to and through the connector and then through an applicator body portion and to the applicator “tip” which physically contacts the glass substrate. Such applicator tip may have any suitable configuration. Preferably, the applicator tip comprises a porous, fibrous, typically inorganic material, preferably a “felt” material, which is capable of controllably transmitting the liquid primer material through it and onto one or more surfaces of the glass substrate.

The felt material has a finite life, typically measured in the number of, for example, vehicle windows to which liquid primer material may be applied by a single applicator tip before its performance is unacceptably degraded. At the time of such applicator tip degradation, the worn tip is removed and is replaced by a new applicator tip. The new tip is preferably conditioned prior to it being fully and acceptably functional. Such conditioning preferably includes: causing the adhesion promoting primer material or the like to flow through the applicator to the tip, and therethrough in an amount in excess of the liquid holding capacity of the felt material of the applicator tip and bringing the applicator tip and a conditioning device into contact with one another, such contact preferably being wiping contact which removes any excess primer material from the applicator tip.

Preferably, the conditioning device is movable, and is capable of moving between at least a conditioning position and a rest position. Such rest position may be in a solvent bath to remove the accumulated primer material from the conditioning device.

After conditioning, the applicator tip is in proper condition to precisely and uniformly apply the proper amount of adhesion-promoting primer material or the like to one or more surfaces of the glass substrate.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 shows a perspective view of an exemplary compliance device of an automated priming system with an exemplary applicator tip applying a liquid to a vehicle window positioned on an exemplary assembly fixture, according to an aspect of the invention.

FIG. 2 shows a perspective view of an applicator tip conditioning device with an applicator tip progressing through the applicator tip conditioning process according to the invention.

FIG. 3 shows an enlarged view of an applicator tip in the conditioning position according to the invention.

FIGS. 4a and 4b show views of the movable applicator tip conditioning device moving from the conditioning position to the rest position according to the invention.

FIG. 5 shows a perspective view of a representative automated priming station with applicator tip conditioning apparatus according to the invention.

### DETAILED DESCRIPTION OF THE INVENTION

The invention relates to applying an adhesion-promoting primer 10 to a glass substrate 12. More particularly, the invention relates to a method of conditioning an applicator tip 14 to uniformly apply an adhesion-promoting primer 10 to a glass vehicle window, and the device for accomplishing such conditioning.

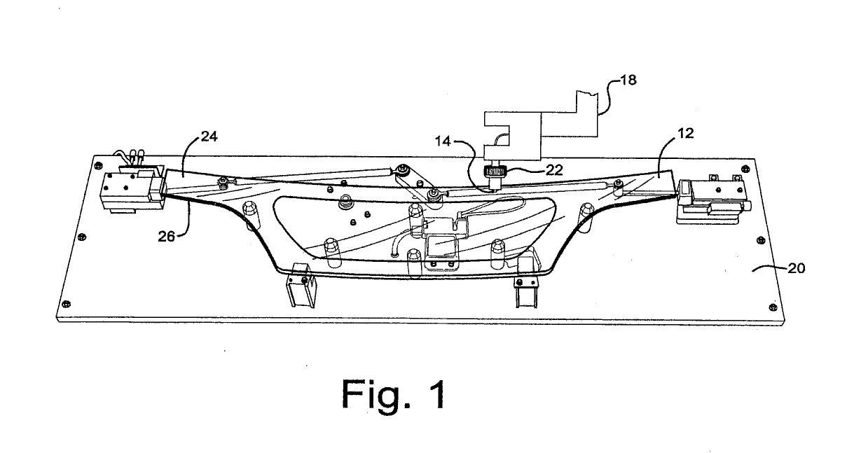

The applicator tip 14 to be conditioned by the conditioning apparatus 16 of the invention is typically a component of an automated priming system. Typically, an automated priming system compatible with the invention includes a so-called compliance mechanism 18 which may be capable of movement in one or more of x, y, and z planes as is schematically illustrated in FIG. 1. The automated priming system is preferably part of a work cell or a work station. Operations which often take place in such work cells include: automated glass sheet placement in a precisely predetermined position on a support structure, such as an assembly fixture 20 for automated application of, for example, one or more liquid adhesion-promoting primers 10 to a peripheral portion of the glass sheet, and automated removal of the primed glass sheet 12 for further processing. Preferably, for purposes of the invention, the glass sheet 12 is a vehicle window.

The liquid adhesion-promoting primer material 10 applied by the automated priming system may be any suitable material, for example, a silane primer or a urethane primer. Such primer materials may be clear, or contain some pigment, so that they may appear black or gray, for example.

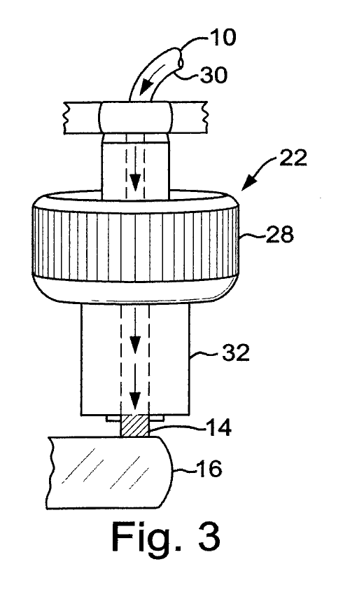

The applicator 22 may have any configuration suitable for applying an adhesion-promoting primer 10 or the like to at least part of one or more surfaces (24, 26) of the peripheral portion of the glass sheet 12. Typically, as shown in FIG. 3, the applicator structure 22 includes an uppermost connector portion 28 to removably attach the applicator 22 in any conventional manner, e.g. snap-fit, screw-on, etc., to a source of liquid adhesion-promoting primer 10 or the like, of any suitable capacity. The liquid primer material 10 preferably flows via an inlet tube 30 or other suitable means to the connector portion 28 of the applicator 22, then through the connector portion 28 to and through an attached applicator body portion 32, and thence to the attached applicator tip portion 14, which physically contacts the desired portion of the glass sheet 12 to which the liquid primer material 10 is to be applied. The connector portion 28 and the applicator body portion 32 are preferably made of a suitable polymeric material. Preferably, the applicator tip 14 comprises a porous, fibrous, typically inorganic material, preferably a “felt” material, which is capable of controllably transmitting the liquid primer material 10 through it, and applying same uniformly onto one or more surfaces (24, 26) of the glass sheet 12. Typically, the fineness of the felt is expressed in denier. Felt of any suitable denier may be utilized.

The felt material, typically, has a finite useful life for uniformly and precisely applying, for example, an adhesion-promoting primer material. The life of the felt material is, typically, measured by the number of glass sheets 12 to which the adhesion-promoting primer 10 has been applied by a single applicator tip 14, before the performance of the applicator tip 14 is unacceptably degraded. Such degradation may be indicated by, for example, a discernible decrease in uniformity of the thickness of the layer of adhesion-promoting primer material 10, and/or a discernible loss in the definition of the lateral edges of the pattern of the primer material 10.

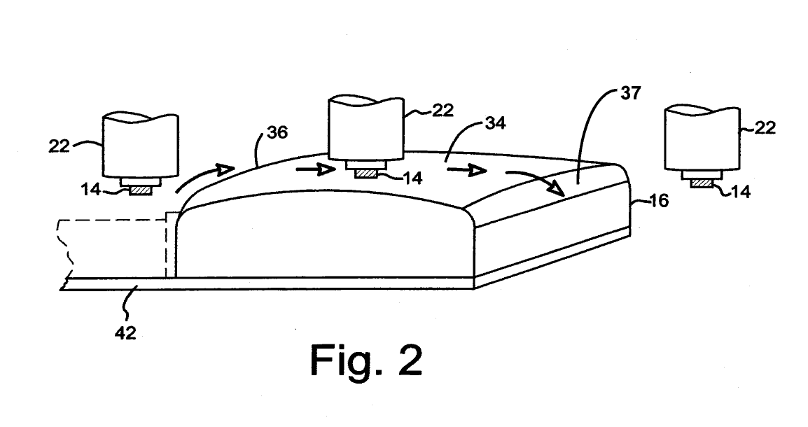

At the time of occurrence of applicator tip 14 degradation, as just described, the worn applicator tip 14 is removed from the applicator body 32, and is replaced by a new applicator tip 14, which may be the same or different than the applicator tip removed, dependent on whether the glass sheet 12, is the same or different than the one which was previously being processed. In order to avoid “start-up” issues, such as too much or too little primer material 10 initially being applied to one or more vehicle windows, it has been discovered to be advantageous for the new applicator tip 14 to be conditioned to ensure that it is fully and acceptably functional. The conditioning process as illustrated in FIG. 2 preferably includes: causing the adhesion-promoting material 10 or the like to flow to and through the new applicator tip 14 in an amount in excess of the liquid holding capacity of the felt material of the applicator tip 14; and bringing the applicator tip 14 and an applicator tip conditioning device 16 into contact with one another, such contact preferably being wiping contact preferably by the compliance mechanism 18 with the applicator tip 14 inserted therein, moving the applicator tip over the surface of conditioning device 16, which conditioning contact removes any excess liquid material 10 from the applicator tip 14, and transfers same to a surface 34 of the applicator tip conditioning device 16. The process downtime associated with the applicator tip conditioning cycle according to the invention is typically less than 20 sec. This time compares favorably to other known method of applicator tip replacement and preparation, e.g. manual replacement which may result in 30 seconds or more process downtime.

Still referring to FIG. 3, the applicator tip conditioning device 16 is formed from a block of any suitable material. For example, the conditioning device 16 may be a block of metal, preferably aluminum and alloys thereof, or stainless steel. The conditioning device 16 may be any suitable shape, but preferably has a rectangular base and a convex top surface 34 with leading edge 36 and trailing edge 37 sloping downward and away from top surface 34. In a particularly preferred configuration, at least the leading edge 36 of the conditioning device 16, i.e. the portion of the conditioning device 16 first contacted by the applicator tip 14 during the conditioning process, may be formed at an angle to the vertical of between 5 degrees and 45 degrees. Preferably at least a portion of the leading edge 36 of the conditioning device 16 is formed at an angle to the vertical of between 5 and 15 degrees. The compliance mechanism 18, to which the applicator tip 14 is preferably attached for purposes of the applicator tip conditioning process, is movable in an x or y direction and is also preferably compliant in a z direction, allowing the applicator tip 14 to gently contact the angled, preferably rounded surface of the leading edge 36 of the conditioning device 16 and then to move thereover, preferably onto the upper horizontal surface 34 of the conditioning device 16.

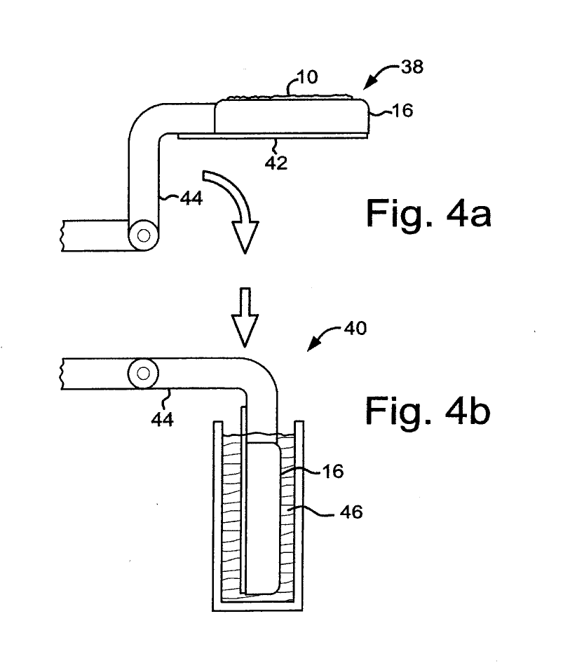

Preferably, the applicator tip conditioning device 16 is also movable, and is capable of moving between at least a conditioning position 38 and a rest position 40, as shown in FIGS. 4a and 4b. In the conditioning position 38, the conditioning device 16 and the applicator tip 14 in compliance mechanism 18 are preferably brought into conditioning contact. In the rest position 40, the conditioning device 16 may be immersed in a solvent bath 46 to remove the accumulated primer material 10 from the conditioning device 16, readying it for its next use.

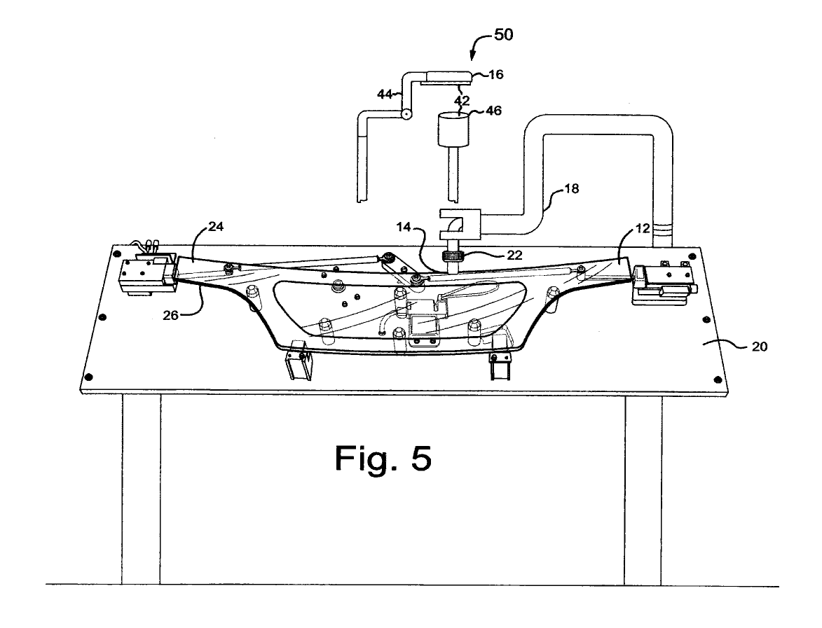

To accomplish movement of the conditioning device 16, any suitable electromechanical means may be utilized. Preferably, the conditioning device 16 is attached to a support structure 42, which support structure 42 is, in turn, affixed to a swing arm 44. Desirably, the movement of the applicator tip conditioning device 16 is electrically and/or mechanically coordinated with operation of the automated priming system. A possible arrangement of a work station including assembly fixture 20, compliance mechanism 18 and applicator tip conditioning assembly 50 is illustrated somewhat schematically in FIG. 5.

Following conditioning, the applicator tip 14 is in proper condition to precisely and uniformly apply the desired amount of adhesion-promoting primer material 10 or the like to one or more surfaces (24, 26) of a vehicle window or the like.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. A method of conditioning an applicator tip for applying a liquid adhesion-promoting primer onto at least one surface of a glass substrate comprising:
providing an automated adhesion-promoting primer application system including a source of the liquid adhesion-promoting primer material flowingly connected to the applicator tip;
causing the liquid adhesion-promoting primer material to flow through the applicator tip in an amount in excess of the holding capacity of the applicator tip;
bringing the applicator tip and an applicator conditioning device into conditioning contact, wherein the excess liquid adhesion-promoting primer material is transferred to the applicator tip conditioning device;
removing the applicator tip conditioning device from contact with the applicator tip; and
bringing the conditioned applicator tip into primer material applying contact with at least one surface of the glass substrate.

2. The method of conditioning an applicator tip defined in claim 1, wherein the applicator tip conditioning device is movable between at least a conditioning contact position and a rest position.

3. The method of conditioning an applicator tip defined in claim 2, wherein movement of the applicator tip conditioning device is electrically and/or mechanically coordinated with operation of the automated priming system.

4. The method of conditioning an applicator tip defined in claim 2, wherein when in the rest position, the applicator tip conditioning device is immersed in a solvent bath.

5. The method of conditioning an applicator tip defined in claim 1, wherein at least that portion of the applicator tip conditioning device that is brought into conditioning contact with the applicator tip comprises a metal.

6. The method of conditioning an applicator tip defined in claim 5, wherein the applicator tip conditioning device comprises aluminum and/or alloys thereof.

7. The method of conditioning an applicator tip defined in claim 6, wherein the applicator tip conditioning device comprises a block of aluminum or alloy of aluminum having a convex top surface with a leading edge and trailing edge sloping downward and away from the convex top surface.

8. The method of conditioning an applicator tip defined in claim 7, wherein at least a portion of the leading edge of the applicator tip conditioning device is formed at an angle between 5 degrees and 45 degrees relative to vertical.

9. The method of conditioning an applicator tip defined in claim 1, wherein the glass substrate is a vehicle window.

10. The method of conditioning an applicator tip defined in claim 9, wherein the vehicle window is supported on an assembly fixture.

11. A device for conditioning an applicator tip comprising:
a block of material having a leading and a trailing edge, at least a portion of the leading edge of the block of material being formed at an angle of between 5 and 45 degrees relative to vertical;
a support mechanism attached to the block of material; and
an electromechanical apparatus connected to the support mechanism to cause movement of the conditioning device between an applicator tip conditioning position and a rest position.

12. The device defined in claim 11, wherein the block of material comprises aluminum or an alloy of aluminum.

13. The device defined in claim 11, wherein the block of material comprises a parallelepiped.
